(19) United States
(12) Patent Application Publication
(10) Pub. No.: US 2018/0285269 A1
(43) Pub. Date: Oct. 4, 2018

(54) AGGREGATING CACHE MAINTENANCE INSTRUCTIONS IN PROCESSOR-BASED DEVICES

(71) Applicant: QUALCOMM Incorporated, San Diego, CA (US)

(72) Inventors: William James McAvoy, Raleigh, NC (US); Thomas Philip Speier, Wake Forest, NC (US); Brian Michael Stempel, Raleigh, NC (US)

(21) Appl. No.: 15/943,130

(22) Filed: Apr. 2, 2018

Related U.S. Application Data
(60) Provisional application No. 62/480,698, filed on Apr. 3, 2017.

(51) Int. Cl. G06F 12/0815; G06F 12/0811; H04L 29/08

(52) U.S. Cl. CPC G06F 12/0815; G06F 2212/62; H04L 67/12; G06F 12/0811

(57) ABSTRACT

Aggregating cache maintenance instructions in processor-based devices is disclosed. In this regard, a processor-based device comprises one or more processing elements (PEs), each providing an aggregation circuit configured to detect a first cache maintenance instruction in an instruction stream. The aggregation circuit then aggregates one or more subsequent, consecutive cache maintenance instructions in the instruction stream with the first cache maintenance instruction until an end condition is detected (e.g., detection of a data synchronization barrier instruction or a cache maintenance instruction targeting a non-consecutive memory address or a different memory page than a previous cache maintenance instruction, and/or detection that an aggregation limit has been exceeded). After detecting the end condition, the aggregation circuit generates a single cache maintenance request representing the aggregated cache maintenance instructions. In this manner, multiple cache maintenance instructions may be represented by and processed as a single request, thus minimizing the impact on system performance.

### PRIORITY APPLICATION

The present application claims priority under 35 U.S.C. § 119(e) to U.S. Provisional Patent Application Ser. No. 62/480,698, filed Apr. 3, 2017 and entitled “AGGREGATING CACHE MAINTENANCE INSTRUCTIONS IN PROCESSOR-BASED SYSTEMS,” the contents of which is incorporated herein by reference in its entirety.

### BACKGROUND

### I. Field of the Disclosure

The technology of the disclosure relates generally to maintenance of system caches in processor-based devices, and, in particular, to providing more efficient execution of multiple cache maintenance instructions.

### II. Background

Conventional processor-based devices make extensive use of system caches to store a variety of frequently used data (including, for example, previously fetched instructions, previously computed values, or copies of data stored in memory). By storing frequently used data in a system cache, a processor-based device can access the data more quickly in response to subsequent requests, thereby decreasing latency and improving overall system performance. To maintain data coherency within the processor-based device, cache maintenance operations are periodically performed on the contents of system caches using cache maintenance instructions. These cache maintenance operations may include “cleaning” the system cache by writing data to a next cache level and/or to system memory, or invalidating data in the system cache by clearing a cache line of data. Cache maintenance operations may be performed in response to modifications to system memory data, access permissions, cache policies, and/or virtual-to-physical address mappings, as non-limiting examples.

In some common use cases, multiple cache maintenance instructions may tend to be issued in “bursts,” in that the multiple cache maintenance instructions exhibit temporal locality. For example, one common use case involves performing a cache maintenance operation for each address within a translation page. Because cache maintenance instructions are typically defined as operating on a single cache line, a separate cache maintenance instruction is required for each cache line corresponding to the contents of the translation page. In this use case, the cache maintenance instructions may begin at the lowest address of the translation page, and proceed through consecutive addresses to the end of the translation page. After the last cache maintenance instruction is executed, a data synchronization barrier instruction may be issued to ensure data synchronization between different executing processes.

However, depending on cache line size and page size, hundreds or even thousands of cache maintenance instructions may need to be executed for a single translation page. If the cache maintenance instructions target memory that may be cached in system caches not owned by the processor executing the cache maintenance instructions, a snoop operation may need to be performed for all other agents that might store a copy of the targeted memory. Consequently, in processor-based devices with a large number of processors, execution of the cache maintenance instructions and associated snoop operations may consume system resources for an excessive number of processor cycles and decrease overall system performance Thus, it is desirable to provide a mechanism for more efficiently executing multiple cache maintenance instructions.

### SUMMARY OF THE DISCLOSURE

Aspects according to the disclosure include aggregating cache maintenance instructions in processor-based devices. In this regard, in some aspects, a processor-based device for aggregating cache maintenance instructions is provided. The processor-based device comprises one or more processing elements (PEs), each of which includes an aggregation circuit. The aggregation circuit is configured to detect a first cache maintenance instruction in an instruction stream of the processor-based device. The aggregation circuit then aggregates one or more subsequent, consecutive cache maintenance instructions in the instruction stream with the first cache maintenance instruction until an end condition is detected. In some aspects, the end condition may include detection of a data synchronization barrier instruction, detection of a cache maintenance instruction with a non-consecutive memory address (relative to the previously detected cache maintenance instructions), detection of a cache maintenance instruction targeting a different memory page than a memory page targeted by the previously detected cache maintenance instructions, and/or detection that an aggregation limit has been exceeded. After detecting the end condition, the aggregation circuit generates a single cache maintenance request representing the aggregated cache maintenance instructions. The single cache maintenance request may then be transmitted to other PEs in aspects providing multiple interconnected PEs. In this manner, multiple cache maintenance instructions (e.g., potentially hundreds or thousands of cache maintenance instructions) may be represented by and processed as a single cache maintenance request, thus minimizing the impact on overall system performance.

In another aspect, a processor-based device for aggregating cache maintenance instructions is provided. The processor-based device comprises one or more PEs, each of which comprises an aggregation circuit. The aggregation circuit is configured to detect a first cache maintenance instruction in an instruction stream of the PE. The aggregation circuit is further configured to aggregate one or more subsequent, consecutive cache maintenance instructions in the instruction stream with the first cache maintenance instruction until an end condition is detected. The aggregation circuit is also configured to generate a single cache maintenance request representing the aggregated one or more subsequent, consecutive cache maintenance instructions.

In another aspect, a processor-based device for aggregating cache maintenance instructions is provided. The processor-based device comprises a means for detecting a first cache maintenance instruction in an instruction stream of a PE of one or more PEs of the processor-based device. The processor-based device further comprises a means for aggregating one or more subsequent, consecutive cache maintenance instructions in the instruction stream with the first cache maintenance instruction until an end condition is detected. The processor-based device also comprises a means for generating a single cache maintenance request representing the aggregated one or more subsequent, consecutive cache maintenance instructions.

In another aspect, a method for aggregating cache maintenance instructions is provided. The method comprises detecting, by an aggregation circuit of a PE of one or more PEs of a processor-based device, a first cache maintenance instruction in an instruction stream of the PE. The method further comprises aggregating one or more subsequent, consecutive cache maintenance instructions in the instruction stream with the first cache maintenance instruction until an end condition is detected. The method also comprises generating a single cache maintenance request representing the aggregated one or more subsequent, consecutive cache maintenance instructions.

### BRIEF DESCRIPTION OF THE FIGURES

FIG. 1 is a block diagram of an exemplary processor-based device providing aggregation of cache maintenance instructions;

FIG. 2 is a block diagram illustrating exemplary aggregation of cache maintenance in an instruction stream by the processor-based device of FIG. 1;

FIG. 3 is a flowchart illustrating an exemplary process for aggregating cache maintenance instructions; and

FIG. 4 is a block diagram of an exemplary processor-based device that may correspond to the processor-based device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

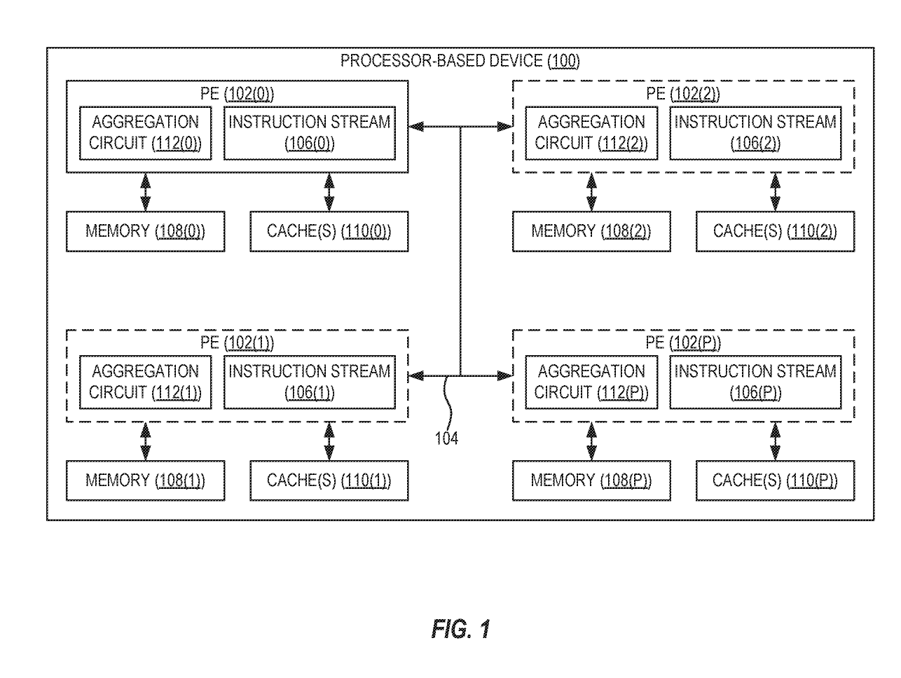

Aspects disclosed in the detailed description include aggregating cache maintenance instructions in processor-based devices. In this regard, FIG. 1 illustrates an exemplary processor-based device 100 that provides multiple processing elements (PEs) 102(0)-102(P) for concurrent processing of executable instructions. Each of the PEs 102(0)-102(P) may comprise a central processing unit (CPU) having one or more processor cores, or an individual processor core comprising a logical execution unit and associated caches and functional units. In the example of FIG. 1, the PEs 102(0)-102(P) are linked via an interconnect bus 104, over which inter-processor communications (such as snoop requests and snoop responses, as non-limiting examples) are communicated. Each of the PEs 102(0)-102(P) is configured to execute a corresponding instruction stream 106(0)-106(P) comprising computer-executable instructions (not shown). It is to be understood that some aspects of the processor-based device 100 may comprise a single PE 102 rather than the multiple PEs 102(0)-102(P) shown in FIG. 1.

The PEs 102(0)-102(P) of FIG. 1 are each associated with a corresponding memory 108(0)-108(P) and one or more caches 110(0)-110(P). Each memory 108(0)-108(P) provides data storage functionality for the associated PE 102(0)-102(P), and may be made up of double data rate (DDR) synchronous dynamic random access memory (SDRAM), as a non-limiting example. The one or more caches 110(0)-110(P) are configured to cache frequently accessed data for the associated PE 102(0)-102(P) in a plurality of cache lines (not shown), and may comprise one or more of a Level 1 (L1) cache, a Level 2 (L2) cache, and/or a Level 3 (L3) cache, as non-limiting examples.

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor sockets or packages. It is to be understood that some aspects of the processor-based device 100 may include elements in addition to those illustrated in FIG. 1. For example, some aspects may include more or fewer PEs 102(0)-102(P), more or fewer memory 108(0)-108(P), and/or more or fewer caches 110(0)-110(P) than illustrated in FIG. 1.

To maintain data coherency, each of the PEs 102(0)-102(P) may execute cache maintenance instructions (not shown) within the corresponding instruction streams 106(0)-106(P) to clean and/or invalidate cache lines of the caches 110(0)-110(P). For example, the PEs 102(0)-102(P) may execute cache maintenance instructions in response to modifications to data stored in the memory 108(0)-108(P), or changes to access permissions, cache policies, and/or virtual-to-physical address mappings, as non-limiting examples. However, depending on cache line size and page size, some common use cases (such as performing cache maintenance operations on each cache line of a translation page) may require hundreds or even thousands of cache maintenance instructions to be executed. This, in turn, may require additional snoop operations to be performed by multiple PEs 102(0)-102(P) that may be caching a copy of the targeted memory. As a result, execution of the cache maintenance instructions and associated snoop operations may consume system resources and decrease overall system performance.

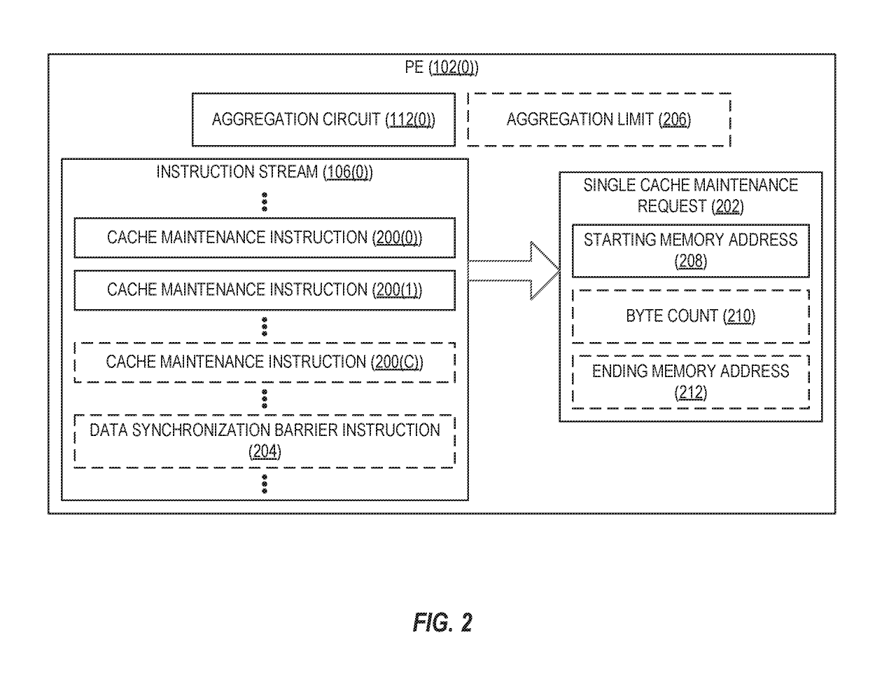

In this regard, the PEs 102(0)-102(P) each provide an aggregation circuit 112(0)-112(P) to aggregate cache maintenance instructions into a single cache maintenance request to facilitate efficient system-wide cache maintenance. In some aspects, the aggregation circuit 112(0)-112(P) for each of the PEs 102(0)-102(P) may be integrated into an execution pipeline (not shown) of the PE 102(0)-102(P), and thus may be operative to detect a cache maintenance instruction prior to execution of the cache maintenance instruction. As discussed in greater detail with respect to FIG. 2, each of the PEs 102(0)-102(P), using the corresponding aggregation circuit 112(0)-112(P), is configured to detect a first cache maintenance instruction within the corresponding instruction streams 106(0)-106(P), and then begin aggregating subsequent cache maintenance instructions rather than continuing to process the cache maintenance instructions for execution. In some aspects, the cache maintenance instructions that are aggregated may comprise cache maintenance instructions that target the same memory page and/or a contiguous range of memory addresses.

Each aggregation circuit 112(0)-112(P) of the PEs 102(0)-102(P) continues to aggregate cache maintenance instructions until an end condition is encountered. The end condition, according to some aspects, may include detection of a data synchronization barrier instruction within the corresponding instruction stream 106(0)-106(P). Some aspects may provide that the end condition includes detection of a cache maintenance instruction that targets a non-consecutive memory address (i.e., a memory address that is not consecutive with respect to the previous aggregated cache maintenance instruction), or a memory address corresponding to a different memory page than the previous aggregated cache maintenance instruction. According to some aspects, the end condition may include detecting that an aggregation limit has been exceeded. For example, the aggregation limit may specify a maximum number of cache maintenance instructions that can be aggregated at one time, or may represent a limit that is to be applied to the memory address (e.g., a boundary between memory pages).

After detecting the end condition, the aggregation circuit 112(0)-112(P) for the executing PE 102(0)-102(P) generates a single cache maintenance request, representing the aggregated cache maintenance instructions. As a non-limiting example, in multi-processor systems, the executing PE 102(0) may transmit the single cache maintenance request to the other PEs 102(0)-102(P). Upon receiving the single cache maintenance request, each of the receiving PEs 102(0)-102(P) performs its own filtering of the single cache maintenance request to identify any memory addresses corresponding to the receiving PE 102(0)-102(P), and performs a cache maintenance operation on each identified memory address. It is to be understood that the process of aggregating and de-aggregating cache maintenance instructions is transparent to any executing software.

FIG. 2 illustrates in greater detail the exemplary aggregation of cache maintenance instructions in the instruction stream 106(0) of the PE 102(0) of FIG. 1. It is to be understood that the PE 102(0) is discussed as an example, and that each of the PEs 102(0)-102(P) may be configured to perform aggregation in the same manner as the PE 102(0). In the example of FIG. 2, the instruction stream 106(0) of the PE 102(0) includes cache maintenance instructions 200(0)-200(C), each of which represents a cache maintenance operation (e.g., cleaning, invalidating, etc.) to be performed. As the PE 102(0) operates on the instruction stream 106(0), the aggregation circuit 112(0) detects the first cache maintenance instruction 200(0). In some aspects, the aggregation circuit 112(0) may be configured to detect any of a specified plurality of instructions related to cache maintenance. Upon detecting the first cache maintenance instruction 200(0), the aggregation circuit 112(0) prevents execution of the cache maintenance instruction 200(0), and begins the process of seeking out subsequent instructions for aggregation.

For each subsequently detected cache maintenance instruction 200(1), 200(C), the aggregation circuit 112(0) of the PE 102(0) determines whether an end condition has been encountered. In some aspects, a data synchronization barrier instruction in the instruction stream 106(0), such as a data synchronization barrier instruction 204, may mark the end of the group of cache maintenance instructions 200(0)-200(C) to be aggregated. Some aspects may provide that the end condition is triggered by the aggregation circuit 112(0) detecting that a cache maintenance instruction, such as the cache maintenance instruction 200(C), targets a memory address that is non-consecutive with respect to the memory addresses targeted by the previous cache maintenance instruction 200(1), or targets a memory address corresponding to a different memory page than that targeted by the previous cache maintenance instructions 200(0), 200(1). According to some aspects, the aggregation circuit 112(0) may determine whether an aggregation limit 206 has been exceeded. For example, the aggregation circuit 112(0) may maintain a count (not shown) of the cache maintenance instructions 200(0)-200(C) that have been aggregated, and may trigger an end condition when the count exceeds a value indicated by the aggregation limit 206. In such aspects, the aggregation limit 206 may represent the maximum number of cache maintenance instructions 200(0)-200(C) to aggregate into a single cache maintenance request 202, and in some aspects may correspond to a maximum number of cache lines for a single page of memory. Some aspects may provide that the aggregation limit 206 may represent a limit, such as a boundary between memory pages, to be applied to each memory address targeted by the cache maintenance instructions 200(0)-200(C).

Once an end condition is encountered, the aggregation circuit 112(0) of the PE 102(0) generates a single cache maintenance request 202 to represent the aggregated cache maintenance instructions 200(0)-200(C). In some aspects, the single cache maintenance request 202 indicates the type of cache maintenance operation to be performed (e.g., cleaning, invalidation, etc.), and further indicates a starting memory address 208 corresponding to the memory address targeted by the first detected cache maintenance instruction 200(0). In some aspects, the single cache maintenance request 202 further includes a byte count 210 that indicates a number of bytes on which to perform the cache maintenance operation. Alternatively, some aspects may provide an ending memory address 212 corresponding to the memory address targeted by the last detected cache maintenance instruction 200(C). In such aspects, the starting memory address 208 and the ending memory address 212 together define a memory address range on which cache maintenance operations are to be performed.

In some aspects providing multiple processors, the PE 102(0) may then transmit the single cache maintenance request 202 to the other PEs 102(1)-102(P), shown in FIG. 1. Upon receiving the single cache maintenance request 202, each of the other PEs 102(1)-102(P) performs filtering operations to determine whether the single cache maintenance request 202 is directed to memory addresses corresponding to the PE 102(1)-102(P), and performs cache maintenance operations accordingly.

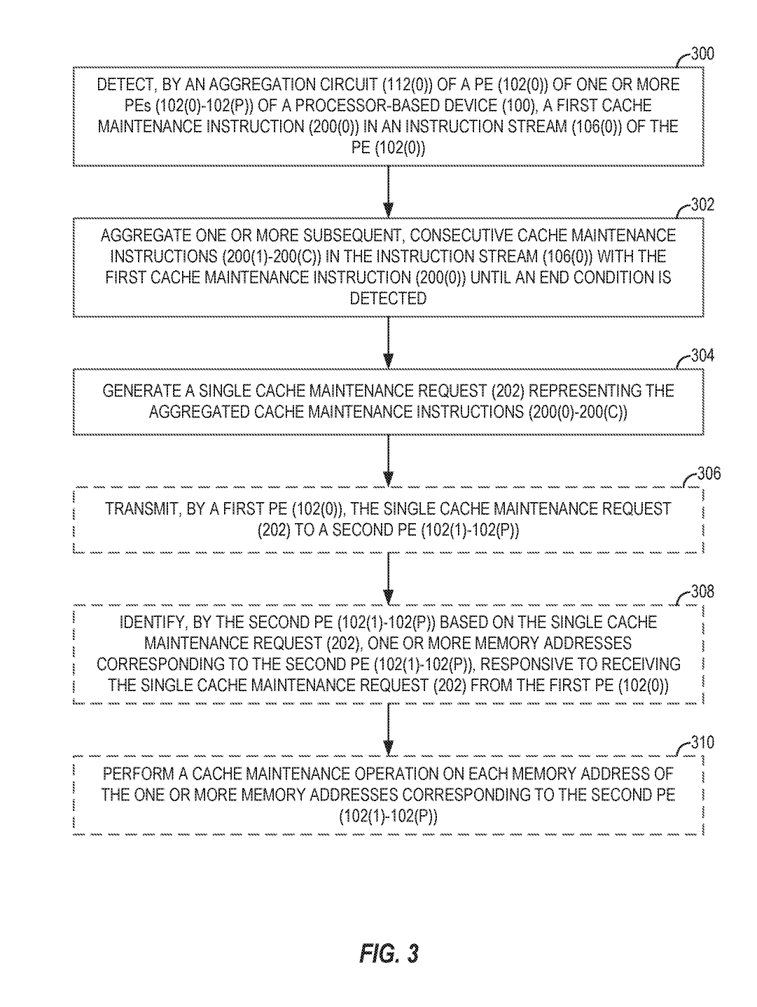

To illustrate exemplary operations of the processor-based device 100 of FIGS. 1 and 2 for aggregating cache maintenance instructions, FIG. 3 is provided. For the sake of clarity, elements of FIGS. 1 and 2 are referenced in describing FIG. 3. In FIG. 3, operations begin with the aggregation circuit 112(0) of the PE 102(0) of the one or more PEs 102(0)-102(P) detecting a first cache maintenance instruction 200(0) in an instruction stream 106(0) of the PE 102(0) (block 300). In this regard, the aggregation circuit 112(0) may be referred to herein as “a means for detecting a first cache maintenance instruction in an instruction stream of a PE of one or more PEs of the processor-based device.”

The aggregation circuit 112(0) next aggregates one or more subsequent, consecutive cache maintenance instructions 200(1)-200(C) in the instruction stream 106(0) with the first cache maintenance instruction 200(0) until an end condition is detected (block 302). Accordingly, the aggregation circuit 112(0) may be referred to herein as “a means for aggregating one or more subsequent, consecutive cache maintenance instructions in the instruction stream with the first cache maintenance instruction until an end condition is detected.” As noted above, the end condition may comprise detection of the data synchronization barrier instruction 204, detection of a cache maintenance instruction 200(C) targeting a non-consecutive memory address or a memory address corresponding to a different memory page, or detection of the aggregation limit 206 being exceeded. The aggregation circuit 112(0) then generates a single cache maintenance request 202 representing the aggregated cache maintenance instructions 200(0)-200(C) (block 304). The aggregation circuit 112(0) thus may be referred to herein as “a means for generating a single cache maintenance request representing the aggregated one or more subsequent, consecutive cache maintenance instructions.”

In aspects providing a plurality of PEs 102(0)-102(P), a first PE, such as the PE 102(0), next may transmit the single cache maintenance request 202 to a second PE, such as one of the PEs 102(1)-102(P) (block 306). In this regard, the first PE 102(0) may be referred to herein as “a means for transmitting the single cache maintenance request from a first PE of the one or more PEs to a second PE of the one or more PEs.” In response to receiving the single cache maintenance request 202, the second PE 102(1)-102(P) may identify one or more memory addresses corresponding to the second PE 102(1)-102(P) based on the single cache maintenance request 202 (block 308). Accordingly, the second PE 102(1)-102(P) may be referred to herein as “a means for identifying, based on the single cache maintenance request, one or more memory addresses corresponding to the second PE, responsive to the second PE receiving the single cache maintenance request from the first PE.” The second PE 102(1)-102(P) may then perform a cache maintenance operation on each memory address of the one or more memory addresses corresponding to the second PE 102(1)-102(P) (block 310). The second PE 102(1)-102(P) thus may be referred to herein as “a means for performing a cache maintenance operation on each memory address of the one or more memory addresses corresponding to the second PE.”

Aggregating cache maintenance instructions in processor-based devices according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

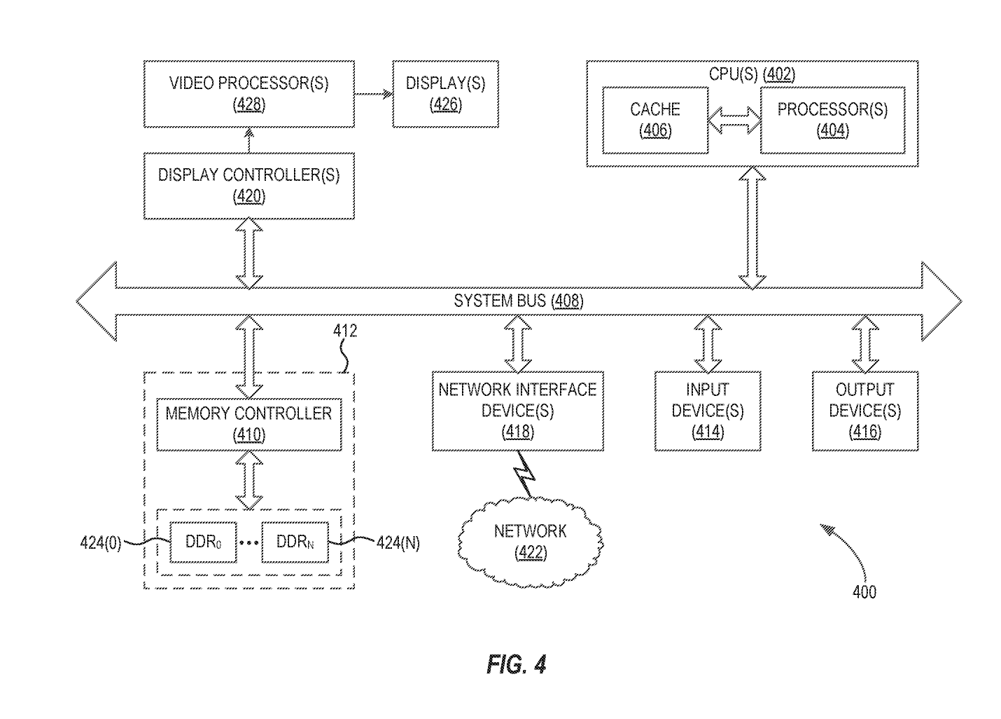

In this regard, FIG. 4 illustrates an example of a processor-based device 400 for aggregating cache maintenance instructions. The processor-based device 400, which corresponds to the processor-based device 100 of FIGS. 1 and 2, includes one or more CPUs 402, each including one or more processors 404. The CPU(s) 402 may have cache memory 406 coupled to the processor(s) 404 for rapid access to temporarily stored data, and in some aspects may correspond to the PEs 102(0)-102(P) of FIG. 1. The CPU(s) 402 is coupled to a system bus 408 and can intercouple master and slave devices included in the processor-based device 400. As is well known, the CPU(s) 402 communicates with these other devices by exchanging address, control, and data information over the system bus 408. For example, the CPU(s) 402 can communicate bus transaction requests to a memory controller 410 as an example of a slave device.

Other master and slave devices can be connected to the system bus 408. As illustrated in FIG. 4, these devices can include a memory system 412, one or more input devices 414, one or more output devices 416, one or more network interface devices 418, and one or more display controllers 420, as examples. The input device(s) 414 can include any type of input device, including but not limited to input keys, switches, voice processors, etc. The output device(s) 416 can include any type of output device, including, but not limited to, audio, video, other visual indicators, etc. The network interface device(s) 418 can be any devices configured to allow exchange of data to and from a network 422. The network 422 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 418 can be configured to support any type of communications protocol desired. The memory system 412 can include one or more memory units 424(0)-424(N).

The CPU(s) 402 may also be configured to access the display controller(s) 420 over the system bus 408 to control information sent to one or more displays 426. The display controller(s) 420 sends information to the display(s) 426 to be displayed via one or more video processors 428, which process the information to be displayed into a format suitable for the display(s) 426. The display(s) 426 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A processor-based device for aggregating cache maintenance instructions, comprising one or more processing elements (PEs), each comprising an aggregation circuit configured to:
detect a first cache maintenance instruction in an instruction stream of the PE;
aggregate one or more subsequent, consecutive cache maintenance instructions in the instruction stream with the first cache maintenance instruction until an end condition is detected; and
generate a single cache maintenance request representing the aggregated one or more subsequent, consecutive cache maintenance instructions.

2. The processor-based device of claim 1, wherein:
the processor-based device comprises a plurality of PEs;
a first PE of the plurality of PEs is configured to transmit the single cache maintenance request to a second PE of the plurality of PEs; and
the second PE of the plurality of PEs is configured to, responsive to receiving the single cache maintenance request from the first PE:
identify, based on the single cache maintenance request, one or more memory addresses corresponding to the second PE; and
perform a cache maintenance operation on each memory address of the one or more memory addresses corresponding to the second PE.

3. The processor-based device of claim 1, wherein the end condition comprises detection of a data synchronization barrier instruction in the instruction stream.

4. The processor-based device of claim 1, wherein the end condition comprises detection of a cache maintenance instruction targeting a non-consecutive memory address relative to a previous aggregated cache maintenance instruction.

5. The processor-based device of claim 1, wherein the end condition comprises detection of a cache maintenance instruction targeting a memory address corresponding to a different memory page than a memory page targeted by a previous aggregated cache maintenance instruction.

6. The processor-based device of claim 1, wherein the end condition comprises detecting that an aggregation limit has been exceeded.

7. The processor-based device of claim 1, wherein the single cache maintenance request comprises a starting memory address and an ending memory address defining a memory address range upon which to perform a cache maintenance operation.

8. The processor-based device of claim 1, wherein the single cache maintenance request comprises a starting memory address corresponding to the first cache maintenance instruction and a byte count indicating a number of bytes on which to perform a cache maintenance operation.

9. The processor-based device of claim 1 integrated into an integrated circuit (IC).

10. The processor-based device of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor-based device for aggregating cache maintenance instructions, comprising:
a means for detecting a first cache maintenance instruction in an instruction stream of a processing element (PE) of one or more PEs of the processor-based device;
a means for aggregating one or more subsequent, consecutive cache maintenance instructions in the instruction stream with the first cache maintenance instruction until an end condition is detected; and
a means for generating a single cache maintenance request representing the aggregated one or more subsequent, consecutive cache maintenance instructions.

12. The processor-based device of claim 11, further comprising:
a means for transmitting the single cache maintenance request from a first PE of the one or more PEs to a second PE of the one or more PEs;
a means for identifying, based on the single cache maintenance request, one or more memory addresses corresponding to the second PE, responsive to the second PE receiving the single cache maintenance request from the first PE; and
a means for performing a cache maintenance operation on each memory address of the one or more memory addresses corresponding to the second PE.

13. A method for aggregating cache maintenance instructions, comprising:
detecting, by an aggregation circuit of a processing element (PE) of one or more PEs of a processor-based device, a first cache maintenance instruction in an instruction stream of the PE;
aggregating one or more subsequent, consecutive cache maintenance instructions in the instruction stream with the first cache maintenance instruction until an end condition is detected; and
generating a single cache maintenance request representing the aggregated one or more subsequent, consecutive cache maintenance instructions.

14. The method of claim 13, wherein:
the processor-based device comprises a plurality of PEs; and
the method further comprises:
transmitting, by a first PE of the plurality of PEs, the single cache maintenance request to a second PE of the plurality of PEs;
identifying, by the second PE based on the single cache maintenance request, one or more memory addresses corresponding to the second PE, responsive to receiving the single cache maintenance request from the first PE; and
performing a cache maintenance operation on each memory address of the one or more memory addresses corresponding to the second PE.

15. The method of claim 13, wherein the end condition comprises detection of a data synchronization barrier instruction in the instruction stream.

16. The method of claim 13, wherein the end condition comprises detection of a cache maintenance instruction targeting a non-consecutive memory address relative to a previous aggregated cache maintenance instruction.

17. The method of claim 13, wherein the end condition comprises detection of a cache maintenance instruction targeting a memory address corresponding to a different memory page than a memory page targeted by a previous aggregated cache maintenance instruction.

18. The method of claim 13, wherein the end condition comprises detecting that an aggregation limit has been exceeded.

19. The method of claim 13, wherein the single cache maintenance request comprises a starting memory address and an ending memory address defining a memory address range upon which to perform a cache maintenance operation.

20. The method of claim 13, wherein the single cache maintenance request comprises a starting memory address corresponding to the first cache maintenance instruction and a byte count indicating a number of bytes on which to perform a cache maintenance operation.
